(19) United States
(12) Patent Application Publication
(10) Pub. No.: US 2011/0127827 A1
(43) Pub. Date: Jun. 2, 2011

(54) PRESSURE RELIEF VALVE

(75) Inventor: Michael John Andrews, Cheshire (GB)

(73) Assignee: STARCO DML LIMITED, Crew, Cheshire (GB)

(21) Appl. No.: 12/745,596

(22) PCT Filed: Oct. 17, 2007
(86) PCT No.: PCT/GB07/03924

§ 371 Date: Feb. 1, 2011

(51) Int. Cl. B60B 21/00; B60B 21/12; F16K 25/00

(52) U.S. Cl. 301/95.101; 251/368

(57) ABSTRACT

A wheel rim for use with an inflatable tyre for a vehicle comprises a pressure relief valve or a weakened section in the rim (11). The valve may comprise a main body (1) having flanges (2, 3) sealing against opposite faces of the rim (11) and legs to retain the valve in the rim. The weakened section may comprise a number of fingers radiating out from a central point. When the pressure inside a tyre on the rim exceeds a certain value the valve or weakened section releases the pressure to prevent over inflation and possible injury.

The present invention relates to a pressure relief valve. The valve is particularly, but not exclusively, intended for use with a wheel having a pneumatic tyre for example a vehicle wheel.

There is a potential for injury when pneumatic tyres are over inflated. Such over inflation may cause the wheel rim and/or tyre to explode resulting in severe injury or death. An object of the present invention is to mitigate or overcome this.

According to one aspect of the present invention there is provided a wheel rim for use with an inflatable tyre for a vehicle in which the rim comprises means for automatically releasing pressure from within the rim when a tyre supported on the rim is inflated above a predetermined pressure.

In a preferred embodiment of the invention the means for automatically releasing pressure comprises a pressure release valve or a weakened section on the rim, or a combination of both. The weakened section may take any desired form. In one form it comprises a number of fingers of thinner section radiating outwardly from a central point which are joined to the remainder of the rim. When the pressure exceeds the predetermined pressure the fingers separate from the remainder of the rim to reveal gaps which releases the excess pressure.

According to another aspect of the present invention, there is provided a pressure relief valve comprising a main body, two spaced flanges extending from the main body one of said flanges being shaped to seal against one surface of an item through which the valve in use extends and the other being shaped to seal against the opposite face of that item and means to prevent passage of the valve through the item.

In a preferred embodiment of the invention the valve is preferably made from rubber or other suitable elastomer although other suitable materials may be used. The use of a thermoplastic elastomer facilitates manufacture of the valve by injection moulding although other methods of manufacture may be employed. The said flange is preferably annular in shape and in cross section preferably has a curved outer periphery. The other flange is substantially advantageously dome shaped and at the point at which it joins the main body is shaped to prevent ingress of dirt and the like. That part of the main body between the two flanges is advantageously cylindrical. The means for preventing passage of the valve through the item preferably comprises two legs extending in substantially opposite directions from the main body at that end of the body remote from the flanges.

In order that the invention may be more clearly understood, one embodiment thereof will now be described, by way of example, with reference to the accompanying drawings, in which:

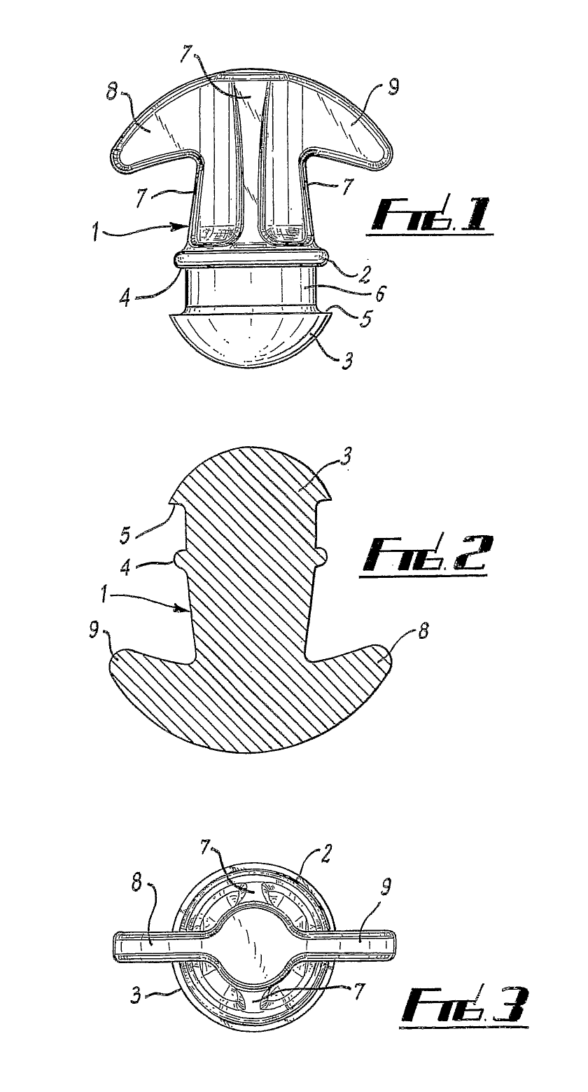

FIG. 1 is a side elevational view of a pressure relief valve;

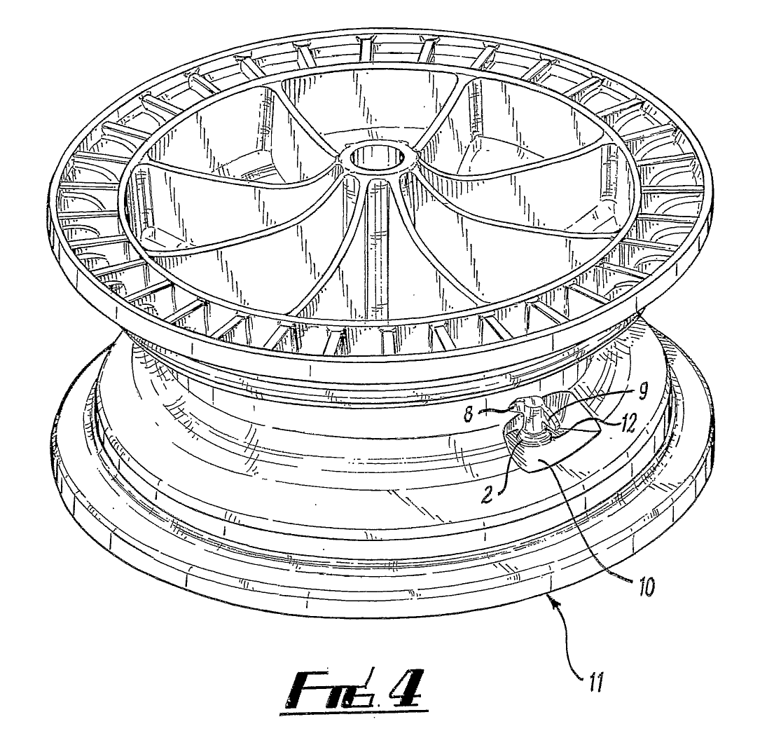

FIG. 2 is a longitudinal cross section of the valve shown in FIG. 1;

FIG. 3 is a plan view of the valve shown in FIGS. 1 and 2;

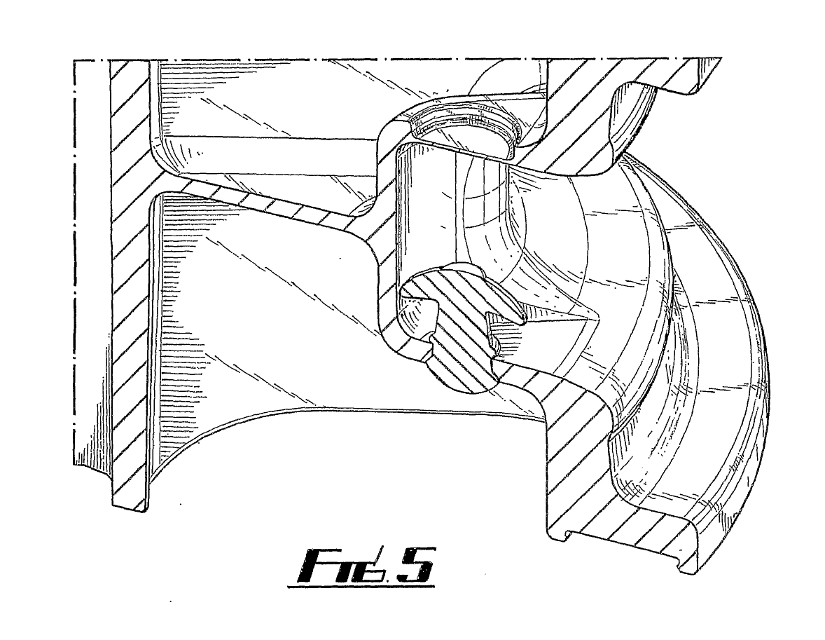

FIG. 4 shows the valve of FIGS. 1 to 3 in position in a wheel rim, and

FIG. 5 is a partial cut away view of the wheel rim of FIG. 4 also showing the valve (in section) in position.

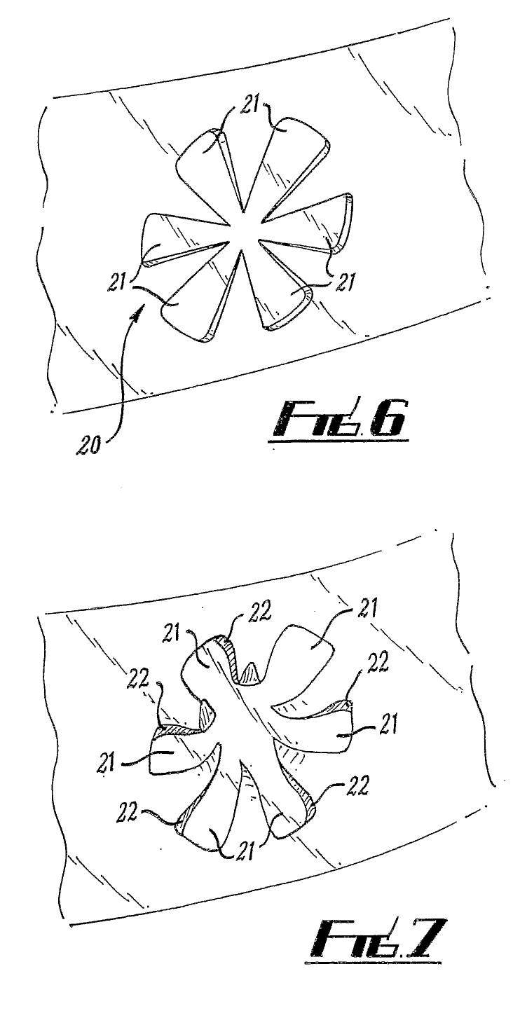

FIG. 6 shows a view of part of a wheel rim with an alternative to the pressure relief valve, and

FIG. 7 shows a part of the wheel rim of FIG. 6 in the released condition.

Referring to FIGS. 1 to 3, the pressure relief valve, which is injection moulded from a thermoplastic elastomer, but which may be made by other methods and of other materials, comprises a main body 1. Towards one end of the main body 1 are disposed two flanges 2 and 3. Flange 2 is annular and in cross section has a curved outer periphery. Its lower surface 4 is shaped for sealing engagement with the inner surface of the wheel rim with which it is to be used as will be described later. The other flange 3 is shaped on its upper surface 5 for sealing engagement with the outer surface of the above mentioned wheel rim. This flange 3 has an inverted dome shape to facilitate its being pushed back into the wheel rim after displacement as will be described later. The section 6 of the main body between flanges 2 and 3 is cylindrical.

The upper part of the main body is formed with strengthening ribs 7 and is provided with means for preventing passage of the valve completely through the rim. These means comprise two legs 8 and 9 extending in diametrically opposite directions from the main body.

In use, referring to FIGS. 4 and 5, the valve is disposed in a recess 10 in the interior of the wheel rim indicated generally by reference numeral 11. The valve itself, which is only partly visible in both FIGS. 4 and 5, is referenced 12. In the sealing position shown in both FIGS. 4 and 5, air loss is prevented from within the rim and a tyre (not shown) mounted on it. The seal is effected between the lower face of flange 2 and the inner surface of the rim. Should the tyre be over inflated the valve is pushed through the aperture in the rim in which it sits thus releasing air from the interior of the rim. Passage of the valve completely through the rim is prevented by the abutment of the legs 8 and 9 with the inner surface of the rim. The valve may be subsequently manually reinstated by pushing the valve back into position using the dome shaped flange 3. The valve is dimensioned and constructed so that it releases well after the tyre has been inflated to its maximum operating pressure but well before there is any danger of the wheel rim exploding. In this particular example, the rim is moulded from plastics material but other materials such as alloys and other metals may be used.

Referring to FIGS. 6 and 7, in an alternative to the pressure relief valve, the rim is provided with a weakened section 20. This weakened section 20 comprises thinner section fingers 21 which are joined to the remainder of the rim. When the pressure reaches the predetermined level the fingers 21 separate from the remainder of the rim to reveal gaps 22 which releases the excess pressure.

If desired the wheel rim may comprise both a pressure release valve and a weakened release section as described above.

It will be appreciated that the above embodiments have been described by way of example only and that many variations are possible without departing from the scope of the invention.

1. A wheel rim for use with an inflatable tyre for a vehicle in which the rim comprises means for automatically releasing pressure from within the rim when a tyre supported on the rim is inflated above a predetermined pressure.

2. A wheel rim as claimed in claim 1, in which the means for automatically releasing pressure comprises a pressure relief valve.

3. A wheel rim as claimed in claim 1, in which the means for automatically releasing pressure comprises a weakened section on the rim.

4. A wheel rim as claimed in claim 1, in which the means for automatically releasing pressure comprises a pressure relief valve and a weakened section on the rim.

5. A wheel rim as claimed in claim 3, in which the weakened section comprises a number of fingers radiating outwardly from a central point and joined to the remainder of the rim.

6. A pressure relief valve comprising a main body, two spaced flanges extending from the main body one of said flanges being shaped to seal against one surface of an item through which the valve in use extends and the other being shaped to seal against the opposite face of that item and means to prevent passage of the valve through the item.

7. A pressure relief valve as claimed in claim 6, in which the valve is made from an elastomer.

8. A pressure relief valve as claimed in claim 7, in which the elastomer is rubber.

9. A pressure relief valve as claimed in claim 7, in which the elastomer is a thermoplastic elastomer.

10. A pressure relief valve as claimed in claim 6, in which the said one flange is annular in shape.

11. A pressure relief valve as claimed in claim 6, in which the said one flange has a curved outer periphery in cross section.

12. A pressure relief valve as claimed in claim 6, in which the said other flange is dome shaped.

13. A pressure relief valve as claimed in claim 6, in which the said other flange is shaped to prevent ingress of dirt at the point in which it joins the main body.

14. A pressure relief valve as claimed in claim 6, in which the shape of the main body between the flanges is cylindrical.

15. A pressure relief valve as claimed in claim 6, in which the means for preventing passage of the valve through the item comprises two legs extending in opposite directions from the main body at that end thereof remote from the flanges.

16. (canceled)

17. (canceled)
